(19) United States
(12) Patent Application Publication
(10) Pub. No.: US 2025/0055940 A1
(43) Pub. Date: Feb. 13, 2025

(54) CONFERENCE CALL INITIATION IMPROVEMENTS

(71) Applicant: QUALCOMM Incorporated, San Diego, CA (US)

(72) Inventors: Poonam MALWAL, Hyderabad (IN); Ankush GANDHI, Sabla (IN); Adil Umar KHAN, Bengaluru (IN); Shrawan KHATRI, San Diego, CA (US); Sreedeep C, Bengaluru (IN); Vinaya Kumara T.V., Bengaluru (IN)

(21) Appl. No.: 18/366,517

(22) Filed: Aug. 7, 2023

(51) Int. Cl. H04M 3/56; H04W 4/16; H04W 76/10

(52) U.S. Cl. CPC H04M 3/563; H04W 4/16; H04W 76/10

(57) ABSTRACT

Certain aspects of the present disclosure provide techniques for improving conference call initiation at a first user equipment (UE). An example method includes initiating a mobile call associated with a second UE, receiving input requesting to add a third UE to the mobile call prior to the mobile call being established with the second UE, and taking one or more actions to establish a mobile conference call with the second UE and the third UE based on the received input prior to the mobile call being established with the second UE.

### BACKGROUND

### Field of the Disclosure

Aspects of the present disclosure relate to wireless communications, and more particularly, to techniques for improving conference call initiation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a first user equipment (UE). The method includes initiating a mobile call associated with a second UE, receiving input requesting to add a third UE to the mobile call prior to the mobile call being established with the second UE, and taking one or more actions to establish a mobile conference call with the second UE and the third UE based on the received input prior to the mobile call being established with the second UE

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5A illustrates a display of a user equipment showing that an add call functionality is inactive prior to a mobile call being established.

FIG. 5B illustrates a display of a user equipment showing that an add call functionality is active after a mobile call has been established.

FIG. 6 includes a call flow diagram illustrating a process for adding an additional user to a mobile call.

FIG. 7 depicts a process flow for communications in a network between a first user equipment, a second user equipment, a third user equipment, and a conference server.

FIG. 8 depicts a process flow for communications in a network between a first user equipment, a second user equipment, a third user equipment, and a conference server.

FIG. 9 depicts a process flow for communications in a network between a first user equipment, a second user equipment, a third user equipment, a fourth user equipment, and a conference server.

FIG. 10 depicts a method for wireless communications.

FIG. 11 depicts aspects of an example communications device.

### DETAILED DESCRIPTION

Aspects of the present disclosure provide apparatuses, methods, processing systems, and computer-readable mediums for improving conference call initiation.

In some cases, a first user of a first user equipment (UE) may desire to communicate with multiple other users, such as a second user associated with a second UE and a third UE associated with a third UE. For example, the first user may initiate a mobile call with the second user associated with the second UE. In some cases, while the mobile call is being established with the second user associated with the second UE, the first user may wish to add the third user associated with the third UE to the mobile call. However, current techniques may prevent the first user associated with the first UE from adding the third user associated with the third UE to the mobile call while the mobile call is still being established with the second user associated with the second UE. This inability to add the third user associated with the third UE may become problematic in certain scenarios, such as when the second user of the second UE does not answer the mobile call or is in poor coverage conditions, causing the first user associated with the first UE to have to wait a significant amount of time to add the third user associated with the third UE to the mobile call and resulting in poor user experience.

Accordingly, aspects of the present disclosure provide techniques for improving conference call initiation. For example, in cases in which the first user has initiated a mobile call with the second user associated with the second UE, the techniques presented herein may allow the first user to add the third user associated with the third UE to the mobile call prior to the mobile call being established with the second user associated with the second UE, thereby avoiding the significant wait time in certain scenarios associated with adding additional users to a call and improving user experience.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

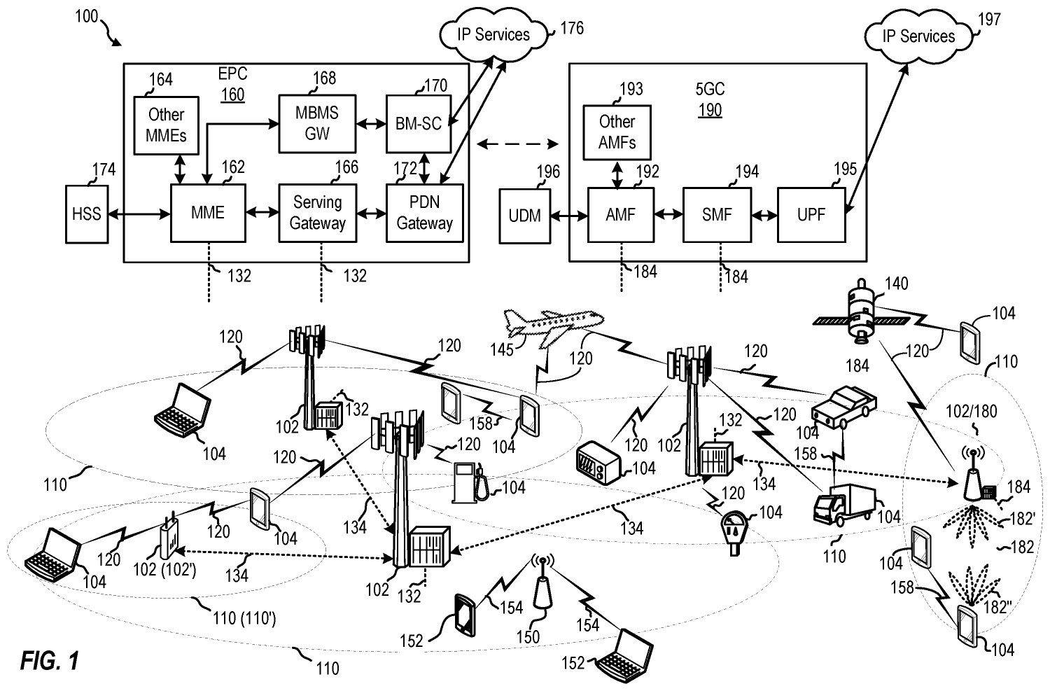

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

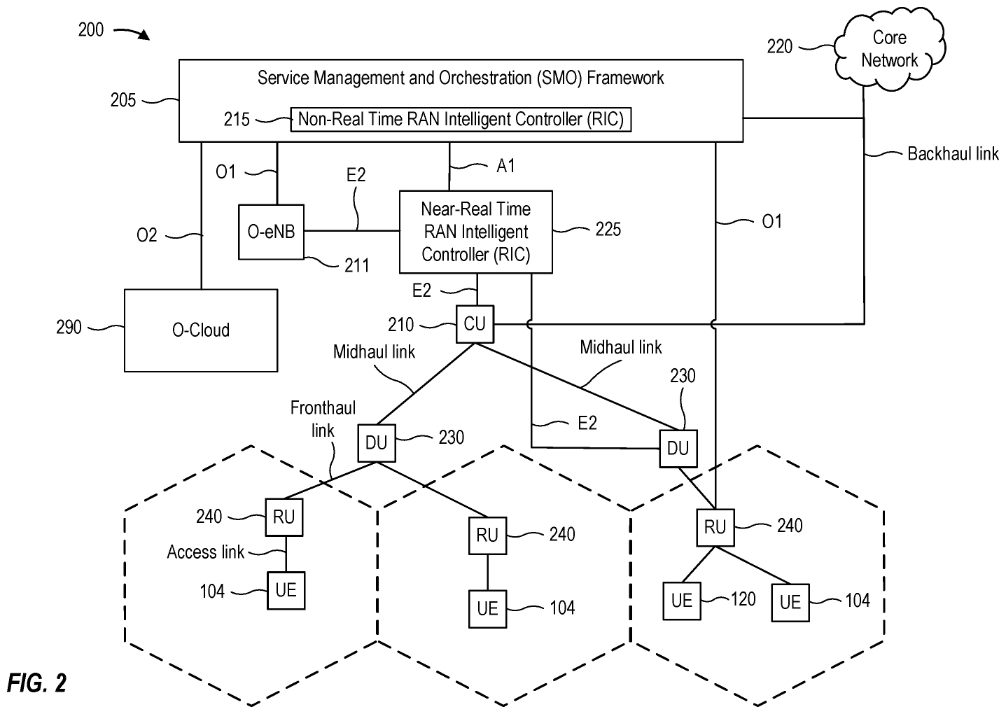

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHZ-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RUs 240 can be implemented to handle over the air (OTA) communications with one or more UEs 104. In some implementations, real-time and non-real-time aspects of control and user plane communications with the RUs 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

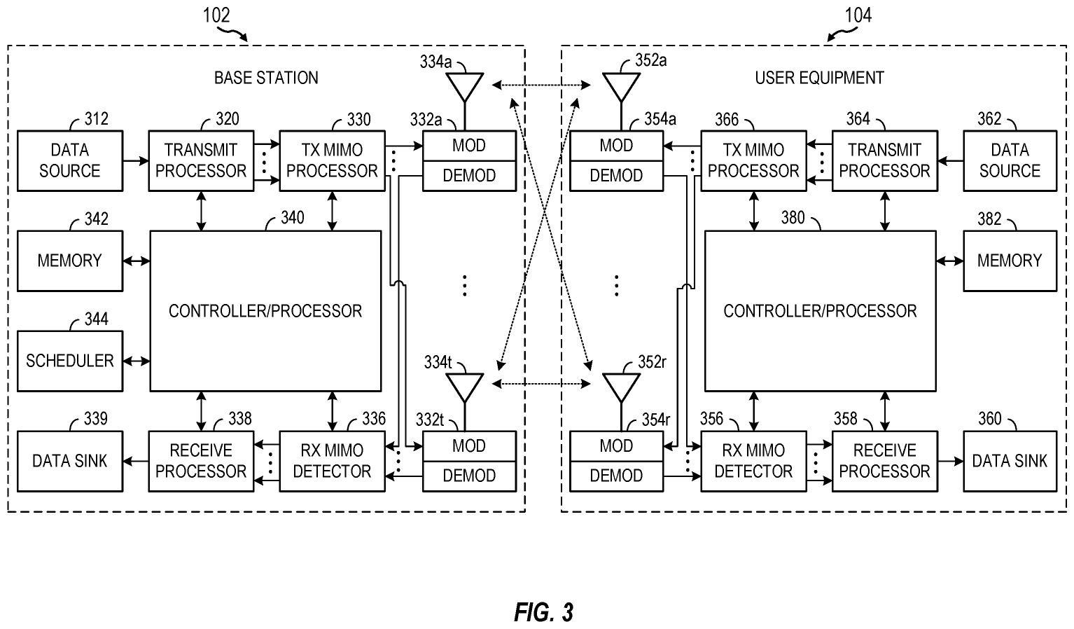

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

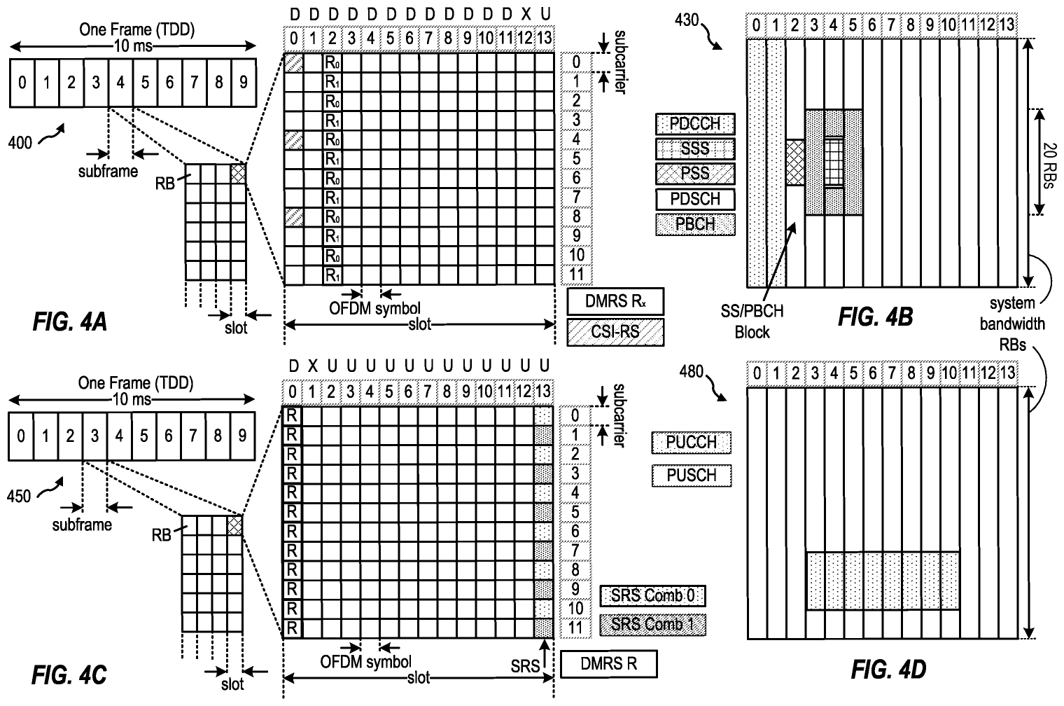

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2u slots/subframe. The subcarrier spacing and symbol length/duration are a function of the numerology. The subcarrier spacing may be equal to 24×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A. 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Conference Call Initiation Improvements

In some cases, when a user (e.g., user-A) of a first user equipment (UE) desires to communicate with multiple other users (e.g., user-B and user-C) of other UEs, user-A may be able to initiate a conference call with user-B and user-C. For example, there may be scenarios in which user-A may first call user-B and, while the call with user-B is being establish, user-A may also wish to add user-C to that call. However, in such scenarios, due to current technology, user-A may not be able to add user-C to that call until after user-B has answered the call and the call has been established. For example, current call establishment logic may specify the initial call with user-B must first be established or connected and, thereafter, a new participant, such as user-C, may be added. In other words, due to current technological limitations, user-A may not be able to add user-C to the call while the call is still being established with user-B (e.g., while the call is still “ringing” at user-A's UE).

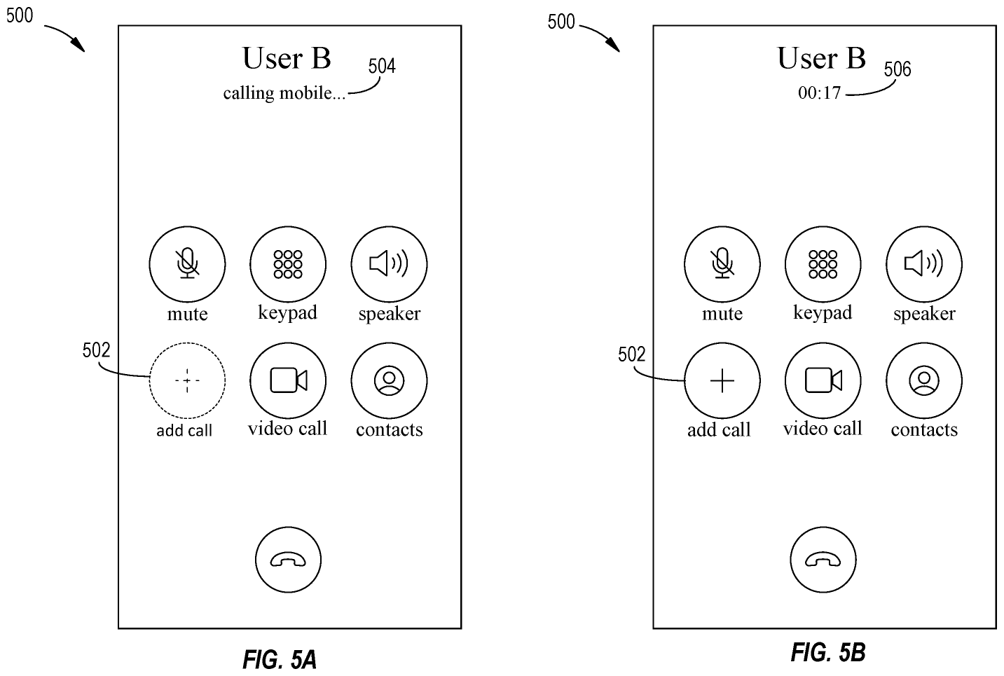

An example of this scenario is illustrated in FIG. 5A. For example, FIG. 5A illustrates a display 500 of the UE of user-A, showing that while the call is being established with user-B, as shown at 504 shown by the label “calling mobile” (e.g., indicating that the mobile call to user-B is ringing, an add call button 502 or functionality is inactive, preventing user-A from adding user-C to the call with user-B. In contrast, as shown on the display 500 in FIG. 5B, after the mobile call with user-B is established, as shown at 506 by a timer indicating how long the call has been established, the add call button 502 becomes active, allowing user-A to add another user, such as user-C, to the call with user-B.

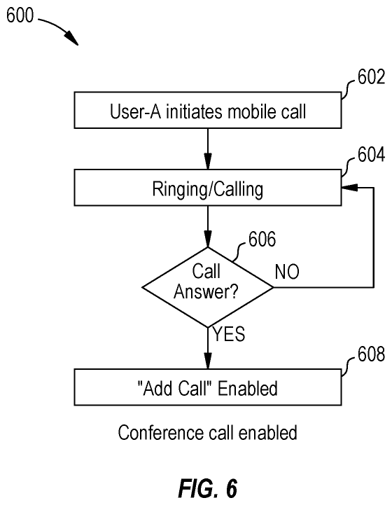

FIG. 6 includes a call flow diagram illustrating a process 600 for adding an additional user to a mobile call according to current techniques. For example, as shown at 602, the process 600 begins with the UE of user-A initiating a call with user-B. Thereafter, as shown at 604, the initiated mobile call with user-B may be ringing. While the mobile call is being established, the UE of user-A may determine whether the mobile call with user-B has been answered, as shown at 606. If the mobile call with user-B has not been answered (e.g., “No” at 606), process 600 returns to 604 with the mobile call continuing to ring. Further, if the mobile call has not been answered by user-B, an ability for user-A to add another user to the mobile call may be disabled, as shown in FIG. 5A. If, however, the call with user-B has been answered (e.g., “Yes” at 606), the process 600 moves to 608 with the ability for user-A to add another user becoming enabled, as shown in FIG. 5B.

In some cases, if user-B is in poor coverage or does not answer the call, a wait time to add user-C to the mobile call may become significant, causing poor user experience. For example, user-A may not wish to wait such a significant amount of time to be able to add user-C to the call simply because user-B does not answer the initial call or may be in poor coverage.

Accordingly, aspects of the present disclosure provide techniques for improving conference call initiation. For example, in cases in which a first user has initiated a call with a second user, the techniques presented herein may allow the first user to add another user to the call prior to the call being established with the second user, thereby avoiding the significant wait time in certain scenarios associated with adding additional users to a call and improving user experience.

### Example Operations for Improving Conference Call Initiation

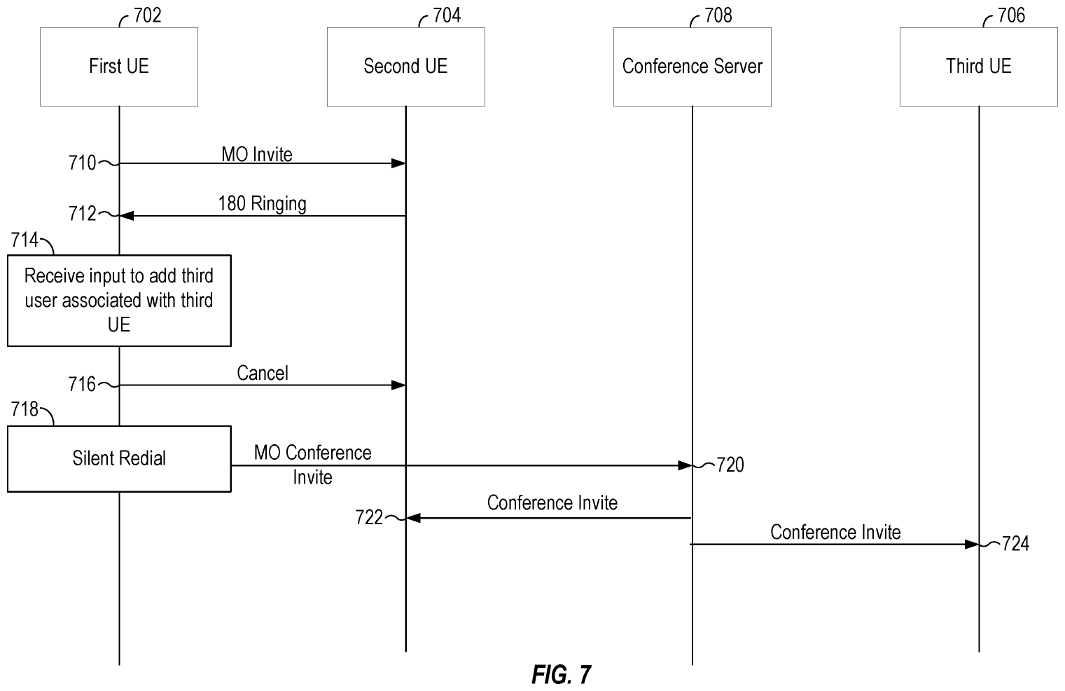

FIG. 7 depicts a process flow including operations 700 for communications in a network between a first UE 702, a second UE 704, a third UE 706, and a conference server 708. In some aspects, the first UE 702, the second UE 704, and the third UE 706 may each be an example of UE 104 depicted and described with respect to FIGS. 1 and 3. In some cases, the conference server 708 may comprise a network entity, for example, in an IP Multimedia Subsystem (IMS). In some cases, the first UE 702 may be associated with a first user, the second UE 704 may be associated with a second user, and the third UE 706 may be associated with a third user.

As shown, operations 700 begin with the first UE 702 initiating a mobile call with the second user associated with the second UE 704 by transmitting a mobile (MO) invitation message to the second UE 704, as shown at 710. In response to receiving the MO invitation message, the second UE 704 may respond to the first UE 702 by sending one or more periodic ringing signals to the first UE 702, as shown at 712. In some cases, the one or more periodic ringing signals may comprise one or more 180 ringing session initiation protocol (SIP) messages. As shown at 714, while the first UE 702 is receiving the one or more periodic ringing signals, the first UE 702 may receive input from the first user of the first UE 702 requesting to add the third user associated with the third UE 706 to the mobile call prior to the mobile call being established with the second UE 704.

Thereafter, in response to receiving the input requesting to add the third user associated with the third UE 706, the first UE 702 may send a cancelation message for the mobile call associated with the second UE 704, as shown at 716. The first UE 702 may then perform a silent redial at 718 (e.g., only at a modem of the first UE 702 without notifying the first user of the first UE 702) to the conference server 708, requesting initiation of a mobile conference call with the second UE 704 and the third UE 706 as participants. For example, as shown at 720, the first UE 702 sends a mobile (MO) conference call invitation message to the conference server 708 indicating the second UE 704 and the third UE 706 as participants. In some cases, the MO conference call invitation message may include SIP uniform resource identifiers (URIs) or phone numbers associated with the second UE 704 and third UE 706. In some cases, the MO conference call invitation message may be sent to the conference server on a same radio access technology (RAT) as a RAT on which the mobile call was initiated in step 710.

Thereafter, as shown at 722 and 724, the conference server 708 may send a conference call invitation message to the second UE 704 and the third UE 706, inviting the second UE 704 and the third UE 706 to a conference call with the first UE 702. Thereafter, the conference call may be established based on the conference call invitation message(s) sent in step 720, step 722, and/or step 724.

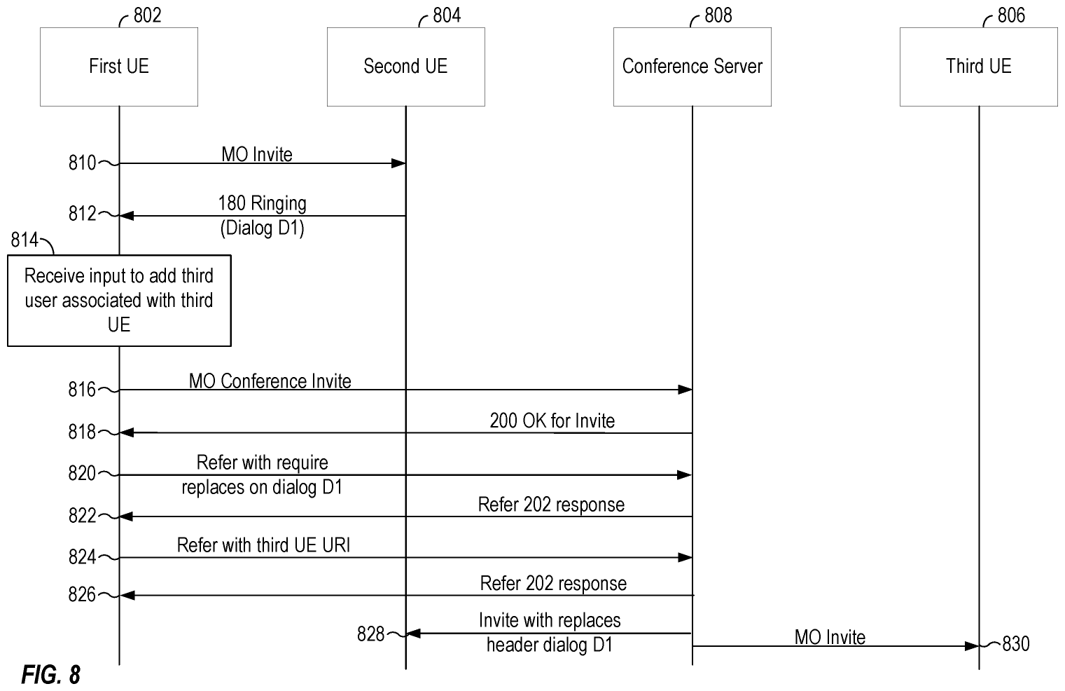

FIG. 8 depicts a process flow including operations 800 for communications in a network between a first UE 802, a second UE 804, a third UE 806, and a conference server 808. In some aspects, the first UE 802, the second UE 804, and the third UE 806 may each be an example of UE 104 depicted and described with respect to FIGS. 1 and 3. In some cases, the conference server 808 may comprise a network entity, for example, in an IMS. In some cases, the first UE 802 may be associated with a first user, the second UE 804 may be associated with a second user, and the third UE 806 may be associated with a third user.

As shown, operations 800 begin with the first UE 802 initiating a mobile call by transmitting a MO invitation message to the second UE 804, as shown at 810. In response to receiving the MO invitation message, the second UE 804 may respond to the first UE 802 by sending one or more periodic ringing signals to the first UE 802, as shown at 812. In some cases, the one or more periodic ringing signals may comprise one or more 180 ringing SIP messages. In some cases, the one or more periodic ringing signals comprise first early dialog information (e.g., dialog D1) indicating at least an identifier of the first UE 802 and an identifier of the second UE 804, such a SIP URIs or phone numbers for the first UE 802 and the second UE 804. As shown at 814, while the first UE 802 is receiving the one or more periodic ringing signals, the first UE 802 may receive input from the first user of the first UE 802 requesting to add the third user associated with the third UE 806 to the mobile call prior to the mobile call being established with the second UE 804.

Thereafter, as shown at 816, in response to receiving the input requesting to add the third UE 806, the first UE 802 may send MO conference call invitation message to the conference server 808 to establish a mobile conference call with the second UE 804 and the third UE 806. Thereafter, as shown at 818, the first UE 802 may receive a first acknowledgement message from the conference server 808 for the mobile conference call invitation message. The first acknowledgement message may comprise a 200 OK SIP message.

Thereafter, as shown at 820, the first UE 802 may send a first request message to the conference server 808 indicating the first early dialog information that was received in the one or more periodic ringing signals. In some cases, the first request message may include a refer message with a “require=replaces” parameter to indicate that dialog D1 needs to be replaced. Thereafter, as shown at 822, the first UE 802 may receive a second acknowledgement message from the conference server 808 for the first request message. In some cases, the second acknowledgement message may comprise a SIP refer 202 response message.

Thereafter, at 824, the first UE 802 sends a second request message to the conference server 808 indicating an identifier of the third UE 806, such as a SIP URI or a phone number of the third UE 806. For example, in some cases, the second request message may comprise a SIP refer message including a SIP URI for the third UE 806. Thereafter, at 826, the first UE 802 may receive a third acknowledgement message from the conference server 808 for the second request message. In some cases, the third acknowledgement message may comprise a SIP refer 202 response message.

Thereafter, as shown at 826, the conference server 808 may send a conference call invitation message to the second UE 804 and the third UE 806, inviting the second UE 804 and the third UE 806 to a conference call with the first UE 802. In some cases, the conference call initiation message sent to the second UE 804 may comprise a SIP invite message with replaces header dialog D1. Thereafter, the conference call may be established based on the conference call invitation message(s) sent in step 816, step 928, and/or step 930.

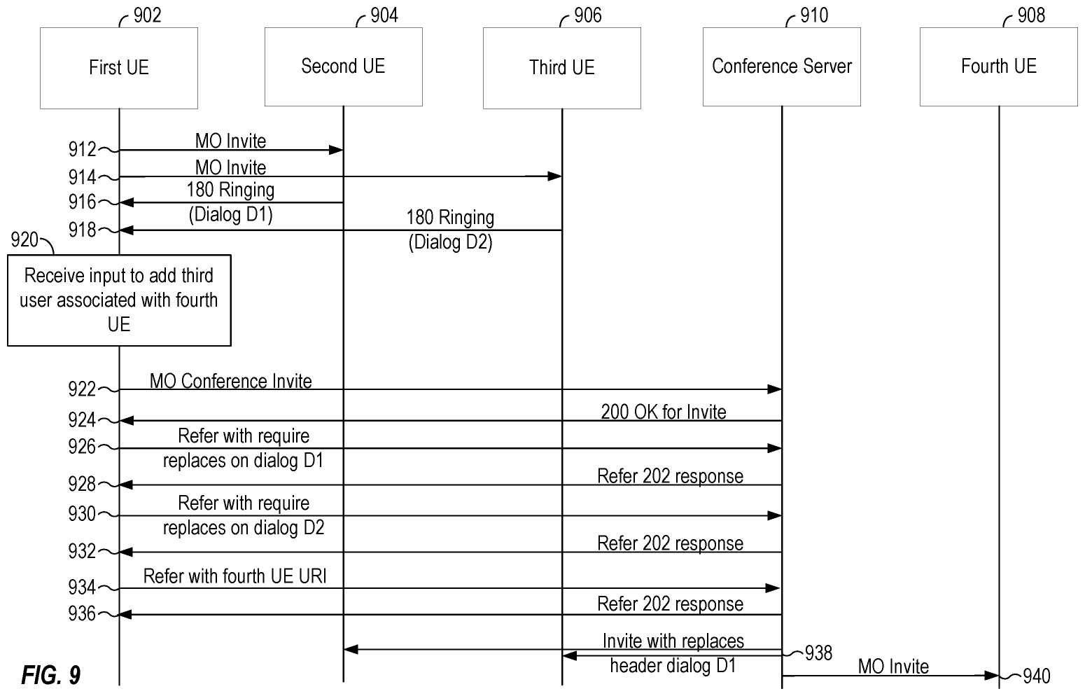

FIG. 9 depicts a process flow including operations 900 for communications in a network between a first UE 902, a second UE 904, third UE 906, a fourth UE 908 and a conference server 910. In some aspects, the first UE 902, the second UE 904, the third UE 906, and fourth UE 908 may each be an example of UE 104 depicted and described with respect to FIGS. 1 and 3. In some cases, the conference server 910 may comprise a network entity, for example, in an IMS. In some cases, the first UE 902 may be associated with a first user, the second UE 904 and third UE 906 may be associated with a second user, and the fourth UE 908 may be associated with a third user. For example, in some cases, the second UE 904 may comprise a mobile phone of the second user and the third UE 906 may comprise a smart watch of the second user (or some other type of device on which the second user is able to receive a mobile call).

As shown, operations 900 begin with the first UE 902 initiating a mobile call with the second user by transmitting a MO invitation message. Because the second user is associated with multiple UEs, the MO invitation message may be forked and routed to both the second UE 904 and the third UE 906 associated with the second user, as shown at 912 and 914, respectively. In response receiving the MO invitation messages, the second UE 904 and the third UE 906 may respond to the first UE 902 by sending one or more periodic ringing signals to the first UE 902, as shown at 916 and 918, respectively. In some cases, the one or more periodic ringing signals may comprise one or more 180 ringing SIP messages.

As shown at 916, the one or more periodic ringing signals from the second UE 904 associated with the second user comprise first early dialog information (e.g., dialog D1) indicating at least an identifier of the first UE 902 and an identifier of the second UE 904, such a SIP URIs or phone numbers for the first UE 902 and the second UE 904. Additionally, as shown 918, the one or more periodic ringing signals from the third UE 906 associated with the second user comprise second early dialog information (e.g., dialog D2) indicating at least an identifier of the first UE 902 and an identifier of the third UE 906, such a SIP URIs or phone numbers for the first UE 902 and the third UE 906.

As shown at 920, while the first UE 902 is receiving the one or more periodic ringing signals, the first UE 902 may receive input from the first user of the first UE 902 requesting to add a fourth UE 908 to the mobile call prior to the mobile call being established with the second UE 904 or the third UE 906 associated with the second user. Thereafter, as shown at 922, in response to receiving the input requesting to add the fourth UE 908, the first UE 902 may send MO conference call invitation message to the conference server 910 to establish a mobile conference call with the fourth UE 908 associated with the third user and at least one of the second UE 904 or third UE 906 associated with the second user.

Thereafter, at 924, the first UE 902 may receive a first acknowledgement message from the conference server 910 for the mobile conference call invitation message. In some cases, the first acknowledgement message may comprise a 200 OK SIP message. Thereafter, at 926, the first UE 902 may send a first request message to the conference server 910 indicating the first early dialog information (e.g., dialog D1) that was received in the one or more periodic ringing signals from the second UE 904. In some cases, the first request message may comprise a refer message with require replaces on dialog D1. Thereafter, at 928, the first UE 902 may receive a second acknowledgement message from the conference server 910 for the first request message. In some cases, the second acknowledgement message may comprise a SIP refer 202 response message.

Thereafter, at 930, the first UE 902 may send a second request message to the conference server 910 indicating the second early dialog information (e.g., dialog D2) that was received in the one or more periodic ringing signals from the third UE 906. In some cases, the second request message may include a refer message with require replaces on dialog D2. Thereafter, at 932, the first UE 902 may receive a third acknowledgement message from the conference server 910 for the second request message. In some cases, the third acknowledgement message may comprise a SIP refer 202 response message.

Thereafter, at 934, the first UE 902 may send a third request message to the conference server 910 indicating an identifier of the fourth UE 908, such as a SIP URI or a phone number of the fourth UE 908. For example, in some cases, the third request message may comprise a SIP refer message including a SIP URI for the fourth UE 908. Thereafter, at 936, the first UE 902 may receive a fourth acknowledgement message from the conference server 910 for the third request message. In some cases, the fourth acknowledgement message may comprise a SIP refer 202 response message.

Thereafter, at 938 and 940, the conference server 910 may send a conference call invitation message to the second UE 904 and/or the third UE 906 associated with the second user and the fourth UE 908 associated with the third user, inviting the second UE 904 and/or the third UE 906 associated with the second user and the fourth UE 908 associated with the third user to a conference call with the first UE 902. In some cases, the conference call initiation message sent to the second UE 904 and/or third UE 906 may comprise an SIP invite message with replaces header dialog D1 or an SIP invite message with replaces header dialog D2, respectively. Thereafter, the conference call may be established based on the conference call invitation message(s) sent in step 922, step 938, and/or step 940.

### Example Operations of a User Equipment

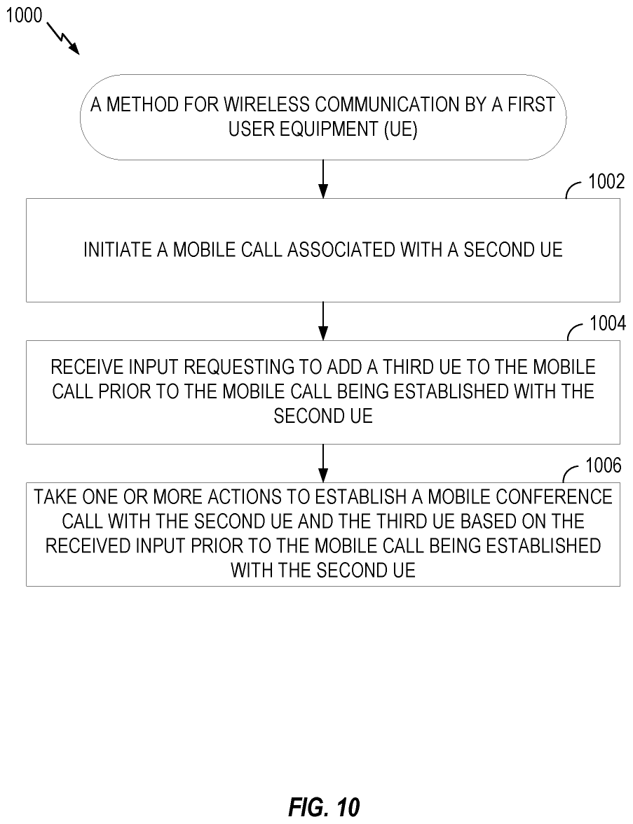

FIG. 10 shows a method 1000 for wireless communication by a first UE, such as UE 104 described with respect to FIG. 1 and FIG. 3.

Method 1000 begins at 1002 with the first UE initiating a mobile call associated with a second UE.

Method 1000 then proceeds to step 1004 with the first UE receiving input from a user of the first UE, adding a third UE to the mobile call prior to the mobile call being established with the second UE.

Method 1000 then proceeds to step 1006 with the first UE taking one or more actions to establish a mobile conference call with the second UE and the third UE based on the received input prior to the mobile call being established with the second UE.

In some cases, method 1000 may further include receiving one or more periodic ringing signals based on the initiated mobile call.

In some cases, receiving the input to add the third UE occurs during reception of the one or more periodic ringing signals.

In some cases, the one or more periodic ringing signals are associated with the second UE.

In some cases, taking the one or more actions in step 1006 comprises sending a cancelation message for the mobile call associated with the second UE.

In some cases, taking the one or more actions in step 1006 sending a mobile conference call invitation message to a conference server indicating the second UE and the third UE as participants. In some cases, taking the one or more actions in step 1006 comprises establishing the mobile conference call with the second UE and the third UE based on the mobile conference call invitation message.

In some cases, the mobile conference call invitation message is sent to the conference server on a same radio access technology (RAT) as a RAT on which the mobile call was initiated.

In some cases, the mobile conference call invitation message is sent as part of a silent redial at the first UE.

In some cases, the one or more periodic ringing signals comprise first early dialog information indicating at least an identifier of the first UE and an identifier of the second UE.

In some cases, taking the one or more actions in step 1006 comprises sending a mobile conference call invitation message to a conference server to establish the mobile conference call. In some cases, taking the one or more actions in step 1006 comprises receiving a first acknowledgement message from the conference server for the mobile conference call invitation message.

In some cases, taking the one or more actions in step 1006 comprises sending a first request message to the conference server indicating the first early dialog information. In some cases, taking the one or more actions in step 1006 comprises receiving a second acknowledgement message from the conference server for the first request message.

In some cases, taking the one or more actions in step 1006 comprises sending a second request message to the conference server indicating an identifier of the third UE. In some cases, taking the one or more actions in step 1006 comprises receiving a third acknowledgement message from the conference server for the second request message.

In some cases, based on the initiated mobile call being forked, the one or more periodic ringing signals comprise a first periodic ringing signal associated with the second UE and a second periodic ringing signal associated with a fourth UE. In some cases, the second UE and the fourth UE are associated with a same user.

In some cases, the first periodic ringing signal associated with the second UE includes the first early dialog information. In some cases, the second periodic ringing signal associated with the fourth UE includes second early dialog information indicating at least an identifier of the first UE and an identifier of a fourth UE.

In some cases, taking the one or more actions in step 1006 comprises sending a mobile conference call invitation message to a conference server to establish the mobile conference call. In some cases, taking the one or more actions in step 1006 comprises receiving a first acknowledgement message from the conference server for the mobile conference call invitation message.

In some cases, taking the one or more actions in step 1006 comprises sending a first request message to the conference server indicating the first early dialog information. In some cases, taking the one or more actions in step 1006 comprises receiving a second acknowledgement message from the conference server for the first request message.

In some cases, taking the one or more actions in step 1006 comprises sending a second request message to the conference server indicating the second early dialog information. In some cases, taking the one or more actions in step 1006 comprises receiving a third acknowledgement message from the conference server for the second request message.

In some cases, taking the one or more actions in step 1006 comprises sending a third request message to the conference server indicating an identifier of the third UE. In some cases, taking the one or more actions in step 1006 comprises receiving a fourth acknowledgement message from the conference server for the third request message.

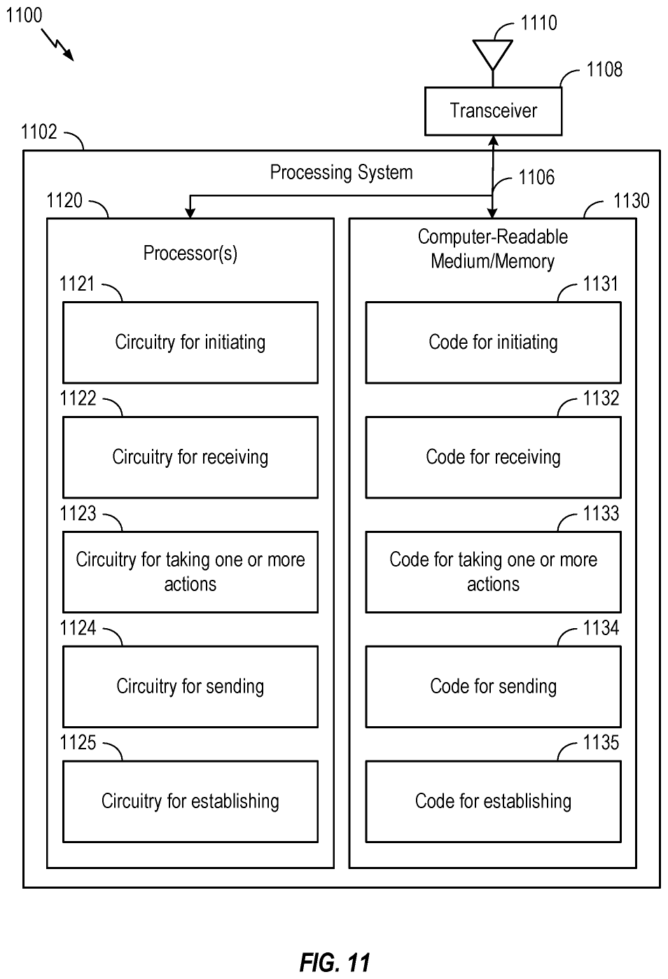

In one aspect, method 1000, or any aspect related to it, may be performed by an apparatus, such as communications device 1100 of FIG. 11, which includes various components operable, configured, or adapted to perform the method 10000. Communications device 1100 is described below in further detail.

Note that FIG. 10 is just one example of a method, and other methods including fewer, additional, or alternative steps are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3, the first UE 702 described with respect to FIG. 7, the first UE 802 described with respect to FIG. 8, or the first UE 902 described with respect to FIG. 9.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 358, transmit processor 364, TX MIMO processor 366, and/or controller/processor 380, as described with respect to FIG. 3. The one or more processors 1120 are coupled to a computer-readable medium/memory 1130 via a bus 1106. In certain aspects, the computer-readable medium/memory 1130 is configured to store instructions (e.g., computer-executable code) that when executed by the one or more processors 1120, cause the one or more processors 1120 to perform the method 1000 described with respect to FIG. 10, or any aspect related to it, and/or one or more of operations 700 described with respect to FIG. 7, operations 800 described with respect to FIG. 8, or operations 900 described with respect to FIG. 9.

Note that reference to one or more processors performing a function of communications device 1100 may include one or more processors performing that function of communications device 1100.

In the depicted example, computer-readable medium/memory 1130 stores code (e.g., executable instructions) for initiating 1131, code for receiving 1132, code for taking one or more actions 1133, code for sending 1134, and code for establishing 1135. Processing of the code 1131-1135 may cause the communications device 1100 to perform the method 1000 described with respect to FIG. 10, or any aspect related to it, and/or one or more of operations 700 described with respect to FIG. 7, operations 800 described with respect to FIG. 8, or operations 900 described with respect to FIG. 9.

The one or more processors 1120 include circuitry configured to implement (e.g., execute) the code stored in the computer-readable medium/memory 1130, including circuitry for initiating 1121, circuitry for receiving 1122, circuitry for taking one or more actions 1123, circuitry for sending 1124, and circuitry for establishing 1125. Processing with circuitry 1121-1125 may cause the communications device 1100 to perform the method 1000 described with respect to FIG. 10, or any aspect related to it, and/or one or more of operations 700 described with respect to FIG. 7, operations 800 described with respect to FIG. 8, or operations 900 described with respect to FIG. 9.

Various components of the communications device 1100 may provide means for performing the method 1000 described with respect to FIG. 10, or any aspect related to it, and/or one or more of operations 700 described with respect to FIG. 7, operations 800 described with respect to FIG. 8, or operations 900 described with respect to FIG. 9. For example, means for transmitting, sending or outputting for transmission may include the transceivers 354 and/or antenna(s) 352 of the UE 104 illustrated in FIG. 3 and/or transceiver 1108 and antenna 1110 of the communications device 1100 in FIG. 11. Means for receiving or obtaining may include the transceivers 354 and/or antenna(s) 352 of the UE 104 illustrated in FIG. 3 and/or transceiver 1108 and antenna 1110 of the communications device 1100 in FIG. 11.

### Example Clauses

Implementation examples are described in the following numbered clauses:

Clause 1: A method for wireless communication by a first user equipment (UE), comprising: initiating a mobile call associated with a second UE; receiving input requesting to add a third UE to the mobile call prior to the mobile call being established with the second UE; and taking one or more actions to establish a mobile conference call with the second UE and the third UE based on the received input prior to the mobile call being established with the second UE.

Clause 2: The method of Clause 1, further comprising receiving one or more periodic ringing signals based on the initiated mobile call.

Clause 3: The method of Clause 2, wherein at least receiving the input to add the third UE occurs during reception of the one or more periodic ringing signals.

Clause 4: The method of any one of Clauses 2-3, wherein the one or more periodic ringing signals are associated with the second UE.

Clause 5: The method of any one of Clauses 2-4, wherein taking the one or more actions comprises sending a cancelation message for the mobile call associated with the second UE.

Clause 6: The method of Clause 5, wherein taking the one or more actions further comprises: sending a mobile conference call invitation message to a conference server indicating the second UE and the third UE as participants; and establishing the mobile conference call with the second UE and the third UE based on the mobile conference call invitation message.

Clause 7: The method of Clause 6, wherein the mobile conference call invitation message is sent to the conference server on a same radio access technology (RAT) as a RAT on which the mobile call was initiated.

Clause 8: The method of any one of Clauses 6-7, wherein the mobile conference call invitation message is sent as part of a silent redial at the first UE.

Clause 9: The method of any one of Clauses 2-8, wherein the one or more periodic ringing signals comprise first early dialog information indicating at least an identifier of the first UE and an identifier of the second UE.

Clause 10: The method of Clause 9, wherein taking the one or more actions comprises: sending a mobile conference call invitation message to a conference server to establish the mobile conference call; and receiving a first acknowledgement message from the conference server for the mobile conference call invitation message.

Clause 11: The method of Clause 10, wherein taking the one or more actions comprises: sending a first request message to the conference server indicating the first early dialog information; and receiving a second acknowledgement message from the conference server for the first request message.

Clause 12: The method of Clause 11, wherein taking the one or more actions comprises: sending a second request message to the conference server indicating an identifier of the third UE; and receiving a third acknowledgement message from the conference server for the second request message.

Clause 13: The method of Clause 9, wherein: based on the initiated mobile call being forked, the one or more periodic ringing signals comprise a first periodic ringing signal associated with the second UE and a second periodic ringing signal associated with a fourth UE; and the second UE and the fourth UE are associated with a same user.

Clause 14: The method of Clause 13, wherein: the first periodic ringing signal associated with the second UE includes the first early dialog information; and the second periodic ringing signal associated with the fourth UE includes second early dialog information indicating at least an identifier of the first UE and an identifier of a fourth UE.

Clause 15: The method of Clause 14, wherein taking the one or more actions comprises: sending a mobile conference call invitation message to a conference server to establish the mobile conference call; and receiving a first acknowledgement message from the conference server for the mobile conference call invitation message.

Clause 16: The method of Clause 15, wherein taking the one or more actions comprises: sending a first request message to the conference server indicating the first early dialog information; and receiving a second acknowledgement message from the conference server for the first request message.

Clause 17: The method of Clause 16, wherein taking the one or more actions comprises: sending a second request message to the conference server indicating the second early dialog information; and receiving a third acknowledgement message from the conference server for the second request message.

Clause 18: The method of Clause 17, wherein taking the one or more actions comprises: sending a third request message to the conference server indicating an identifier of the third UE; and receiving a fourth acknowledgement message from the conference server for the third request message.

Clause 19: An apparatus, comprising: one or more memories comprising executable instructions; and one or more processors configured to execute the executable instructions and cause the apparatus to perform a method in accordance with any one of Clauses 1-18.

Clause 20: An apparatus, comprising means for performing a method in accordance with any one of Clauses 1-18.

Clause 21: A non-transitory computer-readable medium comprising executable instructions that, when executed by one or more processors of an apparatus, cause the apparatus to perform a method in accordance with any one of Clauses 1-18.

Clause 22: A computer program product embodied on a computer-readable storage medium comprising code for performing a method in accordance with any one of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a first user equipment (UE), comprising:
initiating a mobile call associated with a second UE;
receiving input requesting to add a third UE to the mobile call prior to the mobile call being established with the second UE; and
taking one or more actions to establish a mobile conference call with the second UE and the third UE based on the received input prior to the mobile call being established with the second UE.

2. The method of claim 1, further comprising receiving one or more periodic ringing signals based on the initiated mobile call.

3. The method of claim 2, wherein at least receiving the input to add the third UE occurs during reception of the one or more periodic ringing signals.

4. The method of claim 2, wherein the one or more periodic ringing signals are associated with the second UE.

5. The method of claim 2, wherein taking the one or more actions comprises sending a cancelation message for the mobile call associated with the second UE.

6. The method of claim 5, wherein taking the one or more actions further comprises:
sending a mobile conference call invitation message to a conference server indicating the second UE and the third UE as participants; and
establishing the mobile conference call with the second UE and the third UE based on the mobile conference call invitation message.

7. The method of claim 6, wherein:
the mobile conference call invitation message is sent to the conference server on a same radio access technology (RAT) as a RAT on which the mobile call was initiated; and
the mobile conference call invitation message is sent as part of a silent redial at the first UE.

8. The method of claim 2, wherein the one or more periodic ringing signals comprise first early dialog information indicating at least an identifier of the first UE and an identifier of the second UE.

9. The method of claim 8, wherein taking the one or more actions comprises:
sending a mobile conference call invitation message to a conference server to establish the mobile conference call; and
receiving a first acknowledgement message from the conference server for the mobile conference call invitation message.

10. The method of claim 9, wherein taking the one or more actions comprises:
sending a first request message to the conference server indicating the first early dialog information;
receiving a second acknowledgement message from the conference server for the first request message;
sending a second request message to the conference server indicating an identifier of the third UE; and
receiving a third acknowledgement message from the conference server for the second request message.

11. The method of claim 8, wherein:
based on the initiated mobile call being forked, the one or more periodic ringing signals comprise a first periodic ringing signal associated with the second UE and a second periodic ringing signal associated with a fourth UE;
the second UE and the fourth UE are associated with a same user;
the first periodic ringing signal associated with the second UE includes the first early dialog information; and
the second periodic ringing signal associated with the fourth UE includes second early dialog information indicating at least an identifier of the first UE and an identifier of a fourth UE.

12. The method of claim 11, wherein taking the one or more actions comprises:
sending a mobile conference call invitation message to a conference server to establish the mobile conference call; and
receiving a first acknowledgement message from the conference server for the mobile conference call invitation message.

13. The method of claim 12, wherein taking the one or more actions comprises:
sending a first request message to the conference server indicating the first early dialog information; and
receiving a second acknowledgement message from the conference server for the first request message.

14. The method of claim 13, wherein taking the one or more actions comprises:
sending a second request message to the conference server indicating the second early dialog information;
receiving a third acknowledgement message from the conference server for the second request message;
sending a third request message to the conference server indicating an identifier of the third UE; and
receiving a fourth acknowledgement message from the conference server for the third request message.

15. A first user equipment (UE), comprising:
one or more memories comprising executable instructions; and
one or more processors configured to execute the executable instructions and cause the first UE to:
initiate a mobile call associated with a second UE;
receive input requesting to add a third UE to the mobile call prior to the mobile call being established with the second UE; and
take one or more actions to establish a mobile conference call with the second UE and the third UE based on the received input prior to the mobile call being established with the second UE.

16. The first UE of claim 15, wherein the one or more processors are further configured to cause the first UE to receive one or more periodic ringing signals based on the initiated mobile call.

17. The first UE of claim 16, wherein the one or more processors are further configured to cause the first UE to receive the input to add the third UE during reception of the one or more periodic ringing signals.

18. The first UE of claim 16, wherein the one or more periodic ringing signals are associated with the second UE.

19. The first UE of claim 16, wherein, in order to take the one or more actions, the one or more processors are further configured to cause the first UE to send a cancelation message for the mobile call associated with the second UE.

20. The first UE of claim 19, wherein, in order to take the one or more actions, the one or more processors are further configured to cause the first UE to:
send a mobile conference call invitation message to a conference server indicating the second UE and the third UE as participants; and
establish the mobile conference call with the second UE and the third UE based on the mobile conference call invitation message.

21. The first UE of claim 20, wherein:
the mobile conference call invitation message is sent to the conference server on a same radio access technology (RAT) as a RAT on which the mobile call was initiated; and
the mobile conference call invitation message is sent as part of a silent redial at the first UE.

22. The first UE of claim 16, wherein the one or more periodic ringing signals comprise first early dialog information indicating at least an identifier of the first UE and an identifier of the second UE.

23. The first UE of claim 22, wherein, in order to take the one or more actions, the one or more processors are further configured to cause the first UE to:
send a mobile conference call invitation message to a conference server to establish the mobile conference call; and
receive a first acknowledgement message from the conference server for the mobile conference call invitation message.

24. The first UE of claim 23, wherein, in order to take the one or more actions, the one or more processors are further configured to cause the first UE to:
send a first request message to the conference server indicating the first early dialog information;
receive a second acknowledgement message from the conference server for the first request message;
send a second request message to the conference server indicating an identifier of the third UE; and
receive a third acknowledgement message from the conference server for the second request message.

25. The first UE of claim 22, wherein:
based on the initiated mobile call being forked, the one or more periodic ringing signals comprise a first periodic ringing signal associated with the second UE and a second periodic ringing signal associated with a fourth UE;
the second UE and the fourth UE are associated with a same user;
the first periodic ringing signal associated with the second UE includes the first early dialog information; and
the second periodic ringing signal associated with the fourth UE includes second early dialog information indicating at least an identifier of the first UE and an identifier of a fourth UE.

26. The first UE of claim 25, wherein, in order to take the one or more actions, the one or more processors are further configured to cause the first UE to:
send a mobile conference call invitation message to a conference server to establish the mobile conference call; and
receive a first acknowledgement message from the conference server for the mobile conference call invitation message.

27. The first UE of claim 26, wherein, in order to take the one or more actions, the one or more processors are further configured to cause the first UE to:
send a first request message to the conference server indicating the first early dialog information; and
receive a second acknowledgement message from the conference server for the first request message.

28. The first UE of claim 27, wherein, in order to take the one or more actions, the one or more processors are further configured to cause the first UE to:
send a second request message to the conference server indicating the second early dialog information;
receive a third acknowledgement message from the conference server for the second request message;
send a third request message to the conference server indicating an identifier of the third UE; and
receive a fourth acknowledgement message from the conference server for the third request message.

29. An apparatus for wireless communication by a first user equipment (UE), comprising:
means for initiating a mobile call associated with a second UE;
means for receiving input requesting to add a third UE to the mobile call prior to the mobile call being established with the second UE; and
means for taking one or more actions to establish a mobile conference call with the second UE and the third UE based on the received input prior to the mobile call being established with the second UE.

30. A non-transitory computer-readable medium, comprising:
executable instructions that, when executed by one or more processors of a first user equipment (UE), cause the apparatus to:
initiate a mobile call associated with a second UE;
receive input requesting to add a third UE to the mobile call prior to the mobile call being established with the second UE; and
take one or more actions to establish a mobile conference call with the second UE and the third UE based on the received input prior to the mobile call being established with the second UE.
